(19) United States
(12) Patent Application Publication
(10) Pub. No.: US 2011/0014092 A1
(43) Pub. Date: Jan. 20, 2011

(54) GRADUAL-RELEASE DOSING DEVICE FOR SUBSTANCES IN DOMESTIC-USE APPARATUSES, IN THE PRESENCE OF WATER

(75) Inventors: Carla Baratta, Legnano (Verona) (IT); Montserrat Riera, Barcellona (ES); Antonietta Tomasulo, Trento (IT)

Correspondence Address: YOUNG & THOMPSON, 209 Madison Street, Suite 500, Alexandria, VA, 22314, US

(73) Assignee: ZOBELE HOLDING S.P.A., Trento (IT)

(21) Appl. No.: 12/679,152

(22) PCT Filed: Sep. 19, 2008
(86) PCT No.: PCT/IB2008/053817

§ 371 Date: Oct. 6, 2010

(30) Foreign Application Priority Data
Sep. 19, 2007 (IT) BO2007A000633
Apr. 9, 2008 (IT) MI2008A000631

(51) Int. Cl. B01D 11/02

(52) U.S. Cl. 422/261

(57) ABSTRACT

A gradual-release dosing device (1) for at least one agent (3) in both electric and non-electric domestic-use apparatuses, which for the operation thereof require the periodic presence of water—such as for example washing machines, dish-washers, sanitary appliances and the like—includes an outer casing (2) wherein a plurality of doses of the agent (3) is contained, necessary for a corresponding plurality of operation cycles of the apparatus. The casing (2) is defined by a permeable material capable of releasing at least one dose of the agent (3) at each operation cycle.

The object of the present invention is a gradual-release dosing device of substances in both electric and non-electric apparatuses for domestic use which require in particular the periodic presence of water for the operation thereof.

In particular, such invention may be applied in some household electric appliances, for example washing machines or dish-washers, for the release of additive substances during different successive operation cycles, preferred reference whereto will be made in the following by way of example only.

As known, before starting each washing cycle the user pours into the suitable trays, into the dedicated compartments, or into the containers to be introduced directly into the basket, the detergent and other additives, such as for example fabric softener, bleach, antibacterial or antiscale agents.

The market offers an increasingly larger number of products which are soluble or may be suspended in wash water, to be added to the ordinary detergent before the traditional washing cycle, suited to improve wash efficiency or to safeguard the condition of the household electric appliance. In order to obtain the desired results, however, the user must remember to add the above-said substances at each washing cycle, but sometimes, especially with some products, this does not occur due to the user's laziness or distraction.

The antiscale agent, in particular, is a product which the user often forgets to introduce, since it performs a preventive action and hence does not give the user an immediate and practical confirmation, as may instead occur with the softener which makes washed items softer, or bleach which makes the laundry brighter, or dish-washer fragrance diffusers which remove unpleasant odours, or rinse aid which improves dishes polish. These substances cause effects which the user immediately detects with his/her senses and they encourage him/her to make constant use thereof.

Moreover, not all household electrical appliances intended for washing have a dedicated compartment for antiscale introduction, since the problem of the scale deposit on the mechanical components of household electric appliances depends on the user's geographical area, and not all water types have such a hardness index to require a methodical use of an antiscale product.

Similar omissions by the user also regard other products such as for example antibacterial products or the products capable of preserving and cleaning mechanical components of the household electrical appliance such as gaskets, holes for water introduction or pipes carrying the detergent into the wash basket.

Similarly, in sanitary appliances such as the toilet, products are frequently added to preserve hygiene and cleanliness of the toilet bowl.

Such products may be poured manually and periodically into the toilet bowl, but their effectiveness and their stay in the toilet are limited in time due, in particular, to the use of the flusher, and a continuous application of the same is therefore necessary.

In this situation, the technical object underlying the present invention is to propose a gradual-release dosing device of substances in domestic-use apparatuses requiring the presence of water for the operation thereof, capable of avoiding the above-cited drawbacks.

In the framework of said technical task, it is the main object of the present invention to provide a gradual-release dosing device of substances in domestic-use appliances requiring the presence of water which is easy and practical to use and which prevents the user from forgetting to introduce, at each wash or in general at each use of the appliance, any type of substance which may be necessary or useful for better operation of the appliance.

Another object of the invention is to provide a gradual-release dosing device of substances in sanitary appliances such as, for example, the toilet, which may be used for various operation cycles of the appliance.

A further object of the present invention is finally to provide a gradual-release dosing device of substances in domestic-use appliances, which may be used in the appliances of this type already on the market.

The detailed technical task and the specified objects are substantially achieved by means of a gradual-release dosing device of substances in domestic-use appliances, characterised in that it comprises the technical features of one or more of the enclosed claims.

A preferred exemplary non-limiting embodiment is now reported of a gradual-release dosing device for additive substances for a washing machine, according to the accompanying drawings, wherein:

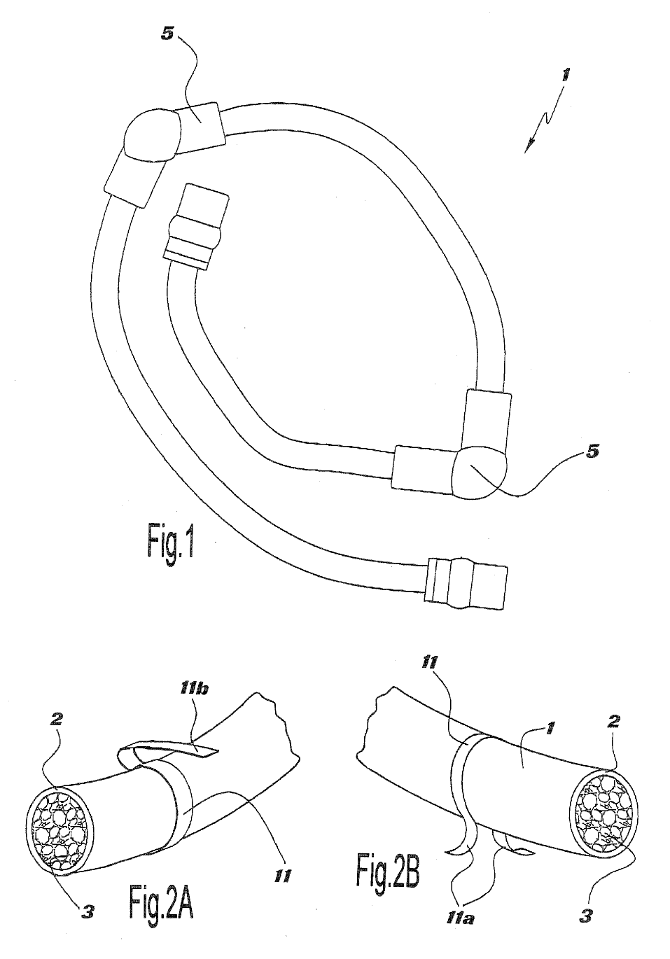

FIG. 1 shows a perspective view of a device according to the present invention;
each of FIGS. 2A and 2B shows an enlarged portion of the device of FIG. 1;

FIG. 3 shows a first application of the device of FIG. 1;

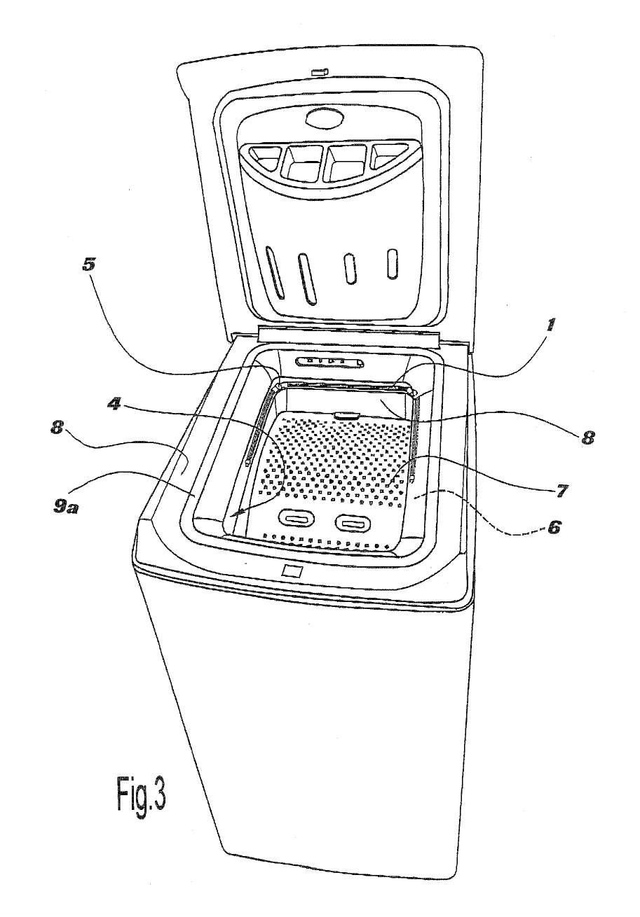

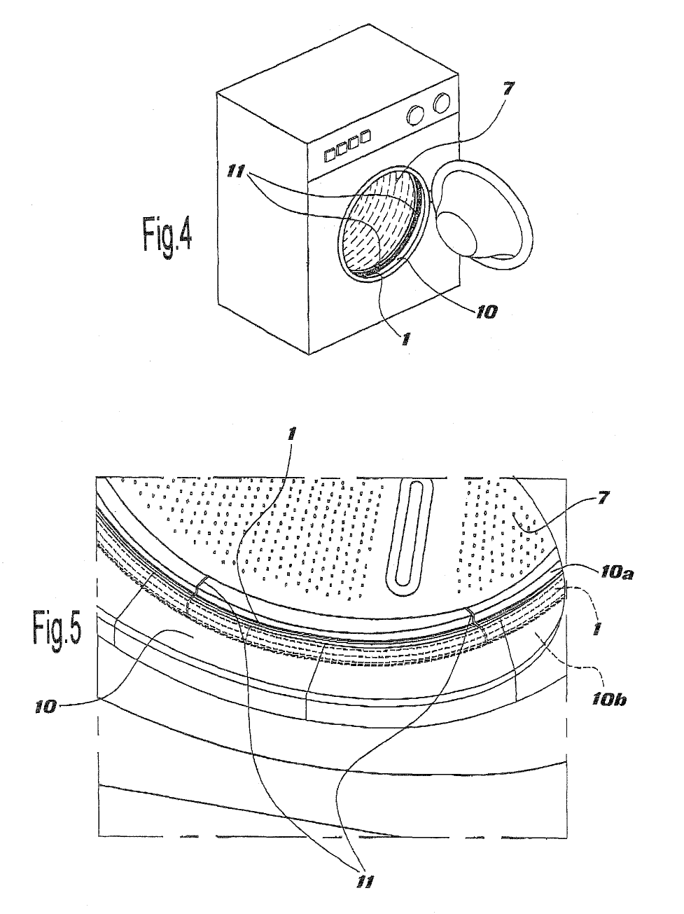

FIG. 4 shows a second application of the device of FIG. 1;

FIG. 5 shows an enlarged detail of a variant of the second application shown in FIG. 4;

FIG. 6 shows a partly sectioned portion of a seal for a washing machine, comprising a device according to the present invention, integrated in the same seal;

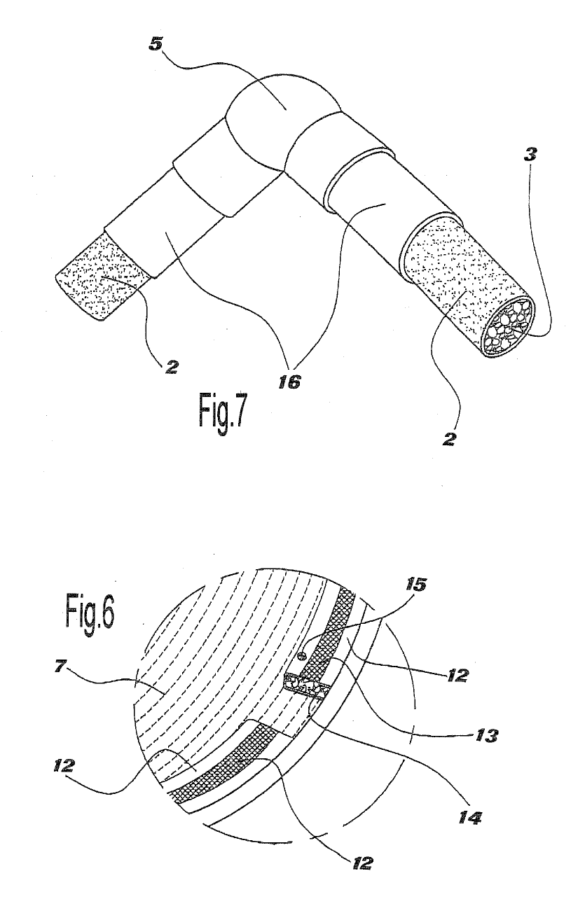

FIG. 7 shows a portion of a different embodiment of the device of FIG. 1;

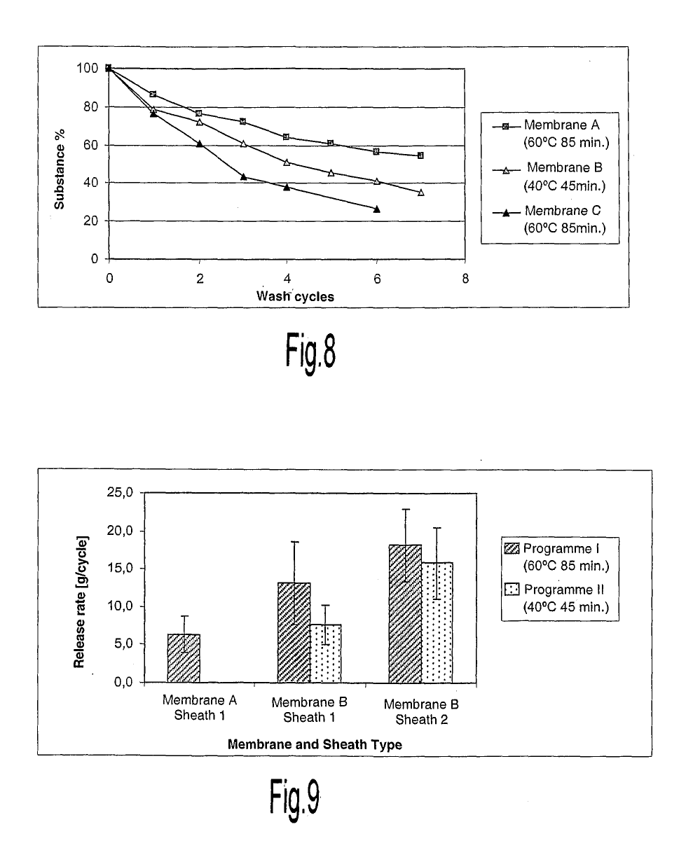

FIGS. 8 and 9 are diagrams representing the substance-release conditions by the dosing device of the invention in some tests carried out in washing machines;

FIGS. 10A, 10B and 10C show respective top plan, side and bottom plan views of a different embodiment of the flexible, protective sheath according to the present invention;

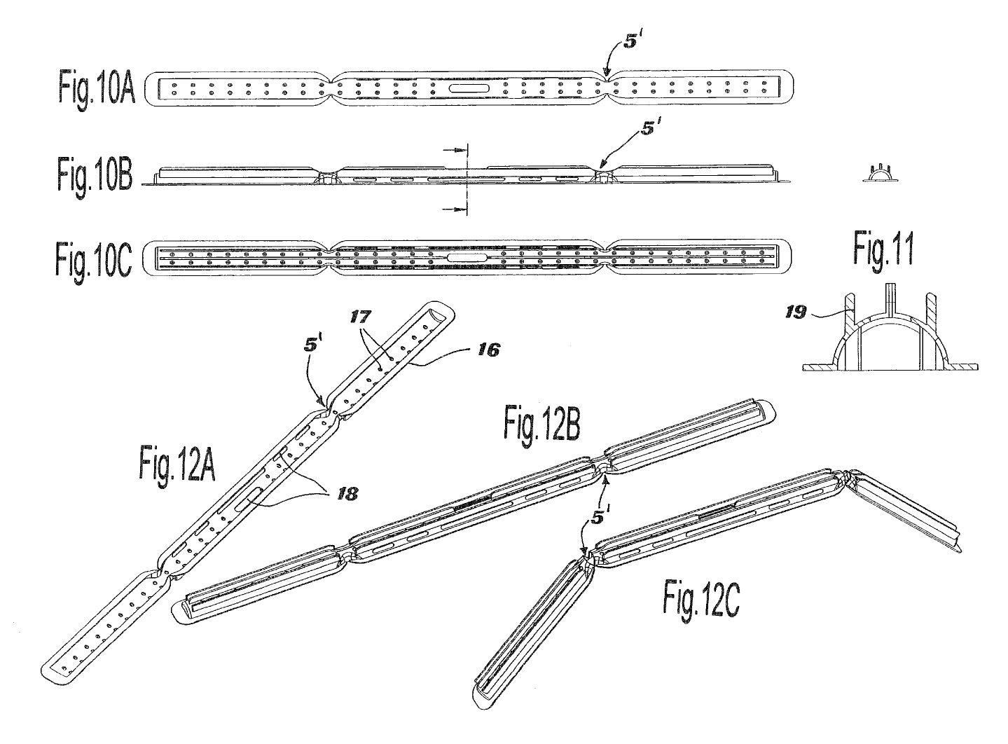

FIG. 11 shows an enlarged-scale cross-section according to the line A-A of FIG. 103; and

FIGS. 12A, 12B and 12C show respective top and bottom perspective views in an extended condition and again bottom views in a folded condition of the flexible, protective sheath of FIG. 10.

A gradual-release dosing device of substances in domestic-use appliances according to the present invention is shown in the enclosed figures under numerical reference 1.

By way of a non-limiting example, reference will be made in the following to the application of the dosing device of the invention to electric appliances and in particular to different types of washing machines.

The device shown in FIG. 1 comprises an outer casing 2 within which an amount of one or more substances 3 is contained, such as antiscale, disinfectants or other similar additives. Of course the substance or the mixture of substances contained within casing 2 may differ even widely from one application to the other, depending on the particular appliance to which the device is applied and on the particular function which one wishes to accomplish in the same.

In the washing machine application disclosed here, these are preferably additive substances 3, to be added to the traditional detergent at each operation cycle of the electrical appliance.

The amount of additive substance 3 contained within casing 2 corresponds to more than a standard dose sufficient for a single operation cycle of the electrical appliance. A quantity equal to a plurality of doses is preferably contained, advantageously ranging between 10 and 500 doses, depending on the type of application and on the frequency of use, so as to have an actual dosing device duration from one to several months.

Casing 2 is at least partly defined by a water-permeable material, advantageously a natural or synthetic polymeric membrane. The material may have hydrophilic features, so as to promote water permeability, but it can also have hydrophobic features, provided its porosity is sufficiently high to allow a water permeability capable of allowing the desired dissolution of substance 3.

In particular it is a membrane which, upon contact with water, or more generically with a work fluid, for example water and detergent, is capable of releasing at least one dose of the substance contained, during each operation cycle of the apparatus, for the entire duration of the useful life of the dosing device. Preferred exemplifying materials for membrane forming are: a cellulose-based hydrophilic membrane, a non-woven fabric, a porous polyethylene membrane, a microperforated polyethylene membrane, or a silicone membrane.

In the case disclosed here of an electric appliance such as the washing machine, the work fluid consists of the wash fluid. In the case of a sanitary appliance such as, for example, a toilet (not shown) instead, the work fluid comprises the water flowing in correspondence of the operation of the flusher normally provided in association with the toilet bowl.

By the term “dose” a certain amount of substance 3 is intended, which is a function of the type and/or of the duration of the washing cycle, or of the amount and/or temperature of the wash water, or again of the physical properties of the water.

For example, in the specific case of an antiscale additive substance, the amount or “dose” of released substance at each wash depends mainly on water hardness.

At the end of each operation cycle in casing 2, a left-over amount of substance 3 remains, ready to be partly released during a subsequent operation cycle, until depletion of substance 3.

The physical features of the membrane making up casing 2 are such as to keep substantially unchanged the chemical properties of the substance which remains within the casing at the end of the wash and so as to cause only a partial, progressive drop of the concentration of such substance or of the amount thereof—depending on whether said substance is initially in a liquid/gel or in a solid form—depending on the dose which is released into the apparatus during the different subsequent operation cycles.

The membrane porosity level, and hence the water permeability thereof, substantially depends on the pore size of the material it consists of. Porosity being equal, permeability may further vary depending on the hydrophilic/hydrophobic character of the material the membrane consists of.

Casing 2 is flexible and deformable. Advantageously, dosing device 1 has an elongated tubular shape, preferably with a circular section.

The diameter of casing 2 ranges between 1 and 5 cm, and the entire device has a length preferably ranging between 20 and 200 cm. The ratio between length and diameter of casing 2 is hence preferably greater than 4, so as to guarantee a wide contact surface between the substance contained in casing 2 and the water which penetrates into the same during the operation cycles.

An embodiment, shown in FIG. 7, provides that casing 2 formed by the polymeric membrane is at least partly covered by a flexible, protective sheath 16. Such sheath 16 is preferably made of water-proof material, for example rubber, and has the purpose of protecting and of giving greater rigidity to the below-lying cellulose membrane, which membrane is particularly fragile in some areas, such as for example near bends or areas subject to greater friction. Protective sheath 16 has holes 17 or windows 18 to allow for controlled release of the substance.

Thus, between the cellulose membrane and sheath 16 a gap is formed (FIG. 7) into which water or the work fluid seep to remove the additive substance.

In an alternative, not-shown solution, outer casing 2 consists of a single layer of material made by sheath portions in a water-proof material separated by portions of cellulose membrane.

In some cases, casing 2 is initially covered also by a water-proof film or coating of water soluble material, to avoid leaks of active substance during the product storage period. Upon first use, the water soluble film or coating melts, thereby putting casing 2 directly in contact with water.

In other cases, casing 2 is initially covered by a peelable film, such as an aluminium barrier sheet, to prevent leaks of active substance during the product storage period. Upon first use, the user must firstly provide to remove the water-proof protective film.

The gradual-release dosing device 1 may be associated with an electrical household appliance, preferably with a washing machine, in a position which—during the operation of the electrical household appliance—is affected by the work fluid, i.e. by clean water or by water already containing detergent.

Moreover, device 1 may preferably be housed in a seat 4 of the device. Preferably, seat 4 should be easy to be inspected by the user. This in consideration of the fact that the user must be able to check the condition of the device and verify if any substance 3 is still found inside, or if the device must be replaced by a new one.

Advantageously, a charge depletion indicator of substance 3 may be provided, or an end-of-life indicator of the dosing device, i.e. an indicator, for example of a mechanical or electronic type, apt to emit a visual and/or sound signal when substance 3 has run out to the point that no release of a dose sufficient for each operation cycle is possible.

In a preferred embodiment, for example, the gradual depletion of the device may be detected by the user by using a coloured substance 3 and detecting the progressive discoloration thereof through casing 2, as the number of washings undergone by the device increases. Thereby the user is capable of perceiving easily when the charge of substance 3 has run out and device 1 must be replaced.

Along the longitudinal length of device 1 a joint 5, preferably two, may be provided to be able to easily shape device 1 according to the geometry of the relative housing seat 4.

In another embodiment, shown in FIGS. 10-12, along protective sheath 16 there is provided at least one folding point 5′ which also allows to shape the device according to the geometry of the relative housing seat 4.

In the case of the toilet, device 1 may be engaged with an annular groove facing towards the bottom of the toilet bowl and normally provided for the circulation of the flushing water.

In the case of a washing machine, advantageously, seat 4, with which the gradual-release device 1 of additive substances 3 may be engaged, is an inner seal of the device.

Preferably, the seat 4 housing device 1 is outside the washing basket, in order to safeguard device 1 both from the high centrifugal forces which develop within the basket, due to the high number of revolutions, and from the friction forces which originate inside the basket, due to the friction between garments.

For example, FIG. 3 shows the device associated with a top-loading washing machine. In the specific case, the device is housed in a groove 6, found in the upper part of the washing machine, bounded by a seal which fully surrounds washing basket 7 and the inner surface of the outer structure 8 of the washing machine. In other words, the inner basket 7 of the washing machine is slung and kept suspended by an element 9 fastened to the outer structure, but capable of slight oscillations to dampen the abrupt basket movements. In the upper part of this element 9 a seal 9a is found which follows the rectangular, inner plant profile of the washing machine, and limits an opening which provides access to inner basket 7. Between this seal 9a and the inner surface of outer structure 8 of the washing machine the cited groove 6 is found, within which device 1 may be housed.

To follow the polygonal geometry of housing seat 4, the device comprises one or more joints 5 which enable device 1 to form even square angles, without outer casing 2 to undergo any stress. In correspondence of such joints, the above-described protective sheath 16 is advantageously provided in an alternative embodiment, said sheath being capable of easily maintaining the geometry of device 1.

In another embodiment, in order to follow the polygonal geometry of the housing seat 4 thereof, protective sheath 16 comprises one or more folding points 5′ which allow the device to form even square angles, without the inner casing undergoing any stress.

The water used for the wash affects also cited groove 6, and then falls back into the basket, carrying with itself part of the substance 3 contained in casing 2.

FIG. 4 shows a second application of the device 1 of the present invention, and FIG. 5 shows a preferred variant of such second application.

In particular, FIGS. 4 and 5 show the device 1 associated with a front-loading washing machine. In both cases the device is housed at the mouth of the basket, in correspondence of the circular inner seal 10 surrounding the washing machine window.

Seal 10 has, along its entire upper surface, a groove 10a communicating with a groove 10b, inwards with respect to seal 10. The preferred solution in the case of a front-loading washing machine, shown in FIG. 5, provides that within the groove 10b of seal 10 device 1 is directly introduced.

In an embodiment, device 1 is equipped with at least one fastening element 11, shown in FIGS. 2A and 2B, capable of ensuring the correct positioning and the positive stability of device 1, especially for toilet flushing devices. In this case, for example, fastening element 11 engages hookwise with the side rim of the toilet bowl, being visible from the outside.

Alternatively, as shown in FIG. 4, device 1 may be rested on seal 10 and kept in position by cited fastening element 11, which this time is introduced into the seal, for example engaging hookwise with the seal lip.

More in detail, in this last case, device 1 remains inside the electric household appliance but outside the wash basket, so as not to be affected by the centrifuge forces and only marginally undergoing the action of the friction forces due to the laundry chafing.

Preferably, two or more fastening elements 11 are provided, clearly shown in FIGS. 2A and 2B, which comprise, for example, rings surrounding casing 2 equipped with flaps 11a, as shown in FIG. 2A, which engage with groove 10a provided on seal 10 or rings surrounding casing 2 provided with clips 11b, as shown in FIG. 2B, which fasten to the side rim or lip of seal 10. Similar fastening elements 11 may be mounted by the user if needed. Should device 1 be installed on top-loading washing machines, fastening elements 11 may possibly be removed; however, the use thereof guarantees a greater stability of device 1.

In alternative embodiments, shown in FIGS. 10-12, the fastening of the device to the seal is accomplished by the friction between longitudinal ribs 19 of the protective sheath and the seal.

Substance 3, contained within casing 2, may alternatively be entirely in a single form, for example a liquid or gel, or a solid powder or pellet (both fluid and agglomerated) form, or it may comprise a liquid or gel part within which powder or pellets of other solid substances are dispersed.

In a preferred embodiment, the substance is of a single type, for example exclusively an antiscale or antibacterial product. In alternative embodiments the substance comprises an array of multiple products mixed together.

Alternative embodiments provide for example the presence of fragrance particles, dispersed within the substance contained in the casing, capable of releasing a pleasant fragrance into the washing machine, removing the odours due to the dampness constantly found in the basket.

In use, when device 1 is affected by the work fluid of the household device or of the electric household appliance, casing 2 releases substance 3 in a suitably dosed amount. The amount of released substance in each operation cycle of the electric household appliance may be adjusted as desired by acting on the porosity of the membrane which makes up casing 2. Moreover, as mentioned above, casing 2 may be partly covered by a water-proof sheath 16, thereby limiting water inlet, in the gap forming between said sheath 16 and casing 2, to the sole areas where sheath 16 is missing.

Advantageously, a seal 12 is a further object of the present invention, said seal being shown in FIG. 6, which acts as a gradual-release dosing device for additive substances in a washing machine. Such seal comprises a casing 13 made of permeable material, within which at least an substance 14 is contained, at least one dose of which is released during an operation cycle of the electric household appliance. Casing 13 is rechargeable and for such purpose has at least one inlet 15 through which it is possible to fill seal 12 when contained substance 14 is depleted.

In this case too substance 14, identical to substance 3 described above, may be in a liquid, gel, or solid form, or a combination of such forms.

The present invention reaches the set objects.

As a matter of fact, the device of the present invention is easy and practical to use, since it is simply housed within the electric household appliance or in the household device, without any problem and very quickly. Once positioned in the respective seat, the device is inconspicuous and does not cause any problem to the user, in particular both during loading and during emptying of the electric household appliance.

The amount of substance contained within the casing is such as to last for a certain number of washes or rinses, so that the user does not need to remember, in particular at each wash, to introduce certain additive substances such as antiscale, antibacterial products or fragrances.

### EXAMPLES

It has been observed experimentally that for ordinary washing machines, both front-loading and top-loading ones, the dosing device according to the present invention ensures perfect cleanliness of the washing machine without compromising the washing efficiency of the washed items.

FIGS. 8 and 9 report the results of some release tests of an antiscale agent from a dosing device according to the invention installed in the seal of an Indesit washing machine, model WIXL 125 with front-opening, using two different wash programmes and two different types of cellulose membrane as casing 2 of the device.

A first wash programme provides a maximum washing temperature of 60° C. and a duration of the wash cycle of 85 minutes. A second wash programme provides instead a lower maximum wash temperature, equal to 40° C., and a shorter duration of the wash cycle, equal to 45 minutes.

A first type of membrane used for forming the casing (shown in the diagrams as membrane A) is a cellulose-based membrane, of the type used for controlled-porosity osmosis. A second type of membrane (shown in the diagrams as membrane B) is instead an ordinary, cellulose-based membrane with a greater porosity than membrane A.

The assessment of the softening effect on the wash water has been assessed by measuring the release rate of the antiscale agent rather than with a direct assessment of wash water hardness, in consideration of the fact that such hardness depends also on other factors and cannot hence represent an exact indication of device operation. The substance release rate has been calculated on the basis of the weight change of dosing device 1 at each washing cycle, taking into account the percentage ratio substance/water found on each occasion within the device, which ratio, as a matter of fact, varies during the use of the device upon decreasing of the concentration or of the substance amount.

As can be noticed examining the diagrams of FIGS. 8 and 9, the percentage of substance decreases with the number of washing cycles. The decrease is faster in the first few washing cycles and tends to stabilise at a constant value during the subsequent washes, so that the release rate does not substantially depend on the left-over amount of substance within the device, and for each washing cycle it is hence possible to obtain a release rate above a preset minimum dose, until depletion of the device.

A depletion indicator of the charge of substance 3, or an end-of-life indicator, for example a visual or sound one, in any case informs the user of the need to replace or recharge the device, before the release rate for each washing cycle drops below said minimum dose.

By examining in particular the diagram of FIG. 9, it can be detected that the release rate—in addition to the fact that it obviously has higher values depending on the wash temperature and on the duration of the washing cycle—may be remarkably changed a priori both by acting on the type of membrane, and on the shape of the sheath 16 used for the protection of casing 2, in particular by changing the shape and arrangement of the areas of casing 2 not covered by sheath 16, through which areas access to the wash water in the gap between sheath 16 and casing 2 is provided. In the diagram of FIG. 2, sheath no. 1 has a wash water access surface smaller than that of sheath no. 2.

Moreover, since some parts of the electrical household appliances—such as for example the seals—are prone to water accumulation and stagnation, wherein moulds may develop and bacteria may proliferate if no thorough and constant cleaning is regularly performed, the additional presence of an antibacterial or anti-mould substance among the various components of the substance 3 contained in the device of the invention guarantees the constant contact thereof with similar elements, and hence a good cleanliness of the electric household appliance. In this way the user is not forced to remember also to clean and dry thoroughly some parts of the electric household appliance.

The device thus conceived is clearly susceptible of industrial application; it may also be subject to a number of changes and variations, all falling within the scope of the invention; moreover, all the details may be replaced by technically equivalent elements, the scope of the invention being exclusively defined in the accompanying claims.

1) Gradual-release dosing device for at least one substance in a domestic-use apparatus comprising the presence of a water-based work fluid, characterised in that it comprises a casing (2) within which a plurality of doses of said substance (3) is contained, necessary for a corresponding plurality of operation cycles of said apparatus, said casing (2) being at least partly defined by a material permeable to said work fluid and capable of releasing at least a dose of said substance (3) at each operation cycle of the apparatus.

2) Device according to claim 1), wherein said permeable material is a polymeric membrane which, upon contact with said work fluid, allows contact of the fluid with the substance contained therein to release at least one dose of said substance (3) during each operation cycle of said apparatus, by dissolution or suspension of the substance in the work fluid, maintaining substantially unchanged the chemical properties of the remaining doses of said substance (3) contained in the casing (2).

3) Device according to claim 2), wherein said polymeric membrane is a hydrophilic cellulose membrane.

4) Device according to claim 1), wherein said casing (2) has an elongated tubular shape.

5) Device according to claim 4), wherein the ratio between the length and the diameter of said casing (2) is above 4.

6) Device according to claim 1), comprising a water-proof protective sheath (16) which covers, at least partly, said casing (2) of permeable material.

7) Device according to claim 6), wherein said casing (2) is flexible and deformable.

8) Device according to claim 7), wherein said sheath is flexible and comprises at least one joint (5) which allows an angular deformation of the device to shape said device according to the geometry of a respective seat (4) of said apparatus into which the device is housed.

9) Device according to claim 8), wherein at least one fastening means is provided to securely fasten the device into the housing seat (4) of said apparatus, said seat being affected, during operation of the apparatus, by said work fluid and, preferably, being easy to be inspected by the user.

10) Device according to claim 9), wherein said seat consists of a seal (9a; 10) inside the apparatus.

11) Device according to claim 1), further comprising an indicator to signal the depletion of the substance (3).

12) Device according to claim 11), wherein said indicator is a visual indicator consisting of the colour change exhibited by said substance upon the progressive depletion thereof.

13) Device according to claim 1), wherein said substance (3) contained in the casing (2) is in a liquid or gel form and exhibits a progressive concentration drop upon each operation cycle.

14) Device according to claim 1), wherein said substance (3) contained in the casing (2) is in solid form, in powder or pellets, both fluid and agglomerated, which is dissolved in the subsequent washing cycles showing a progressive quantity drop at each operation cycle.

15) Device according to claim 1), wherein said substance (3) contained in the casing (2) consists of a part in a solid form and of a part in a liquid or gel form, mixed with each other.

16) Device according to claim 1), wherein said dose of substance released during each operation cycle of the apparatus may be adjusted at will by changing the porosity of the permeable membrane which makes up the casing (2).

17) Device according to claim 1), wherein said dose of substance released during each operation cycle of the apparatus may be adjusted at will by changing the configuration and the size of the areas of said casing (2) not covered by said sheath (16).

18) Seal of a domestic-use apparatus which comprises the presence of a water-based work fluid, characterised in that it comprises a casing (13) of permeable material containing an substance (14) inside, at least one dose of said substance being releasable during an operation cycle of the apparatus.

19) Seal according to claim 18), wherein said casing (13) is rechargeable with said substance (14) through one or more inlets (15).
